(19) United States
(12) Patent Application Publication
(10) Pub. No.: US 2006/0068119 A1
(43) Pub. Date: Mar. 30, 2006

(54) Process for producing papermachine clothing

(76) Inventor: Ian Sayers, Preston (GB)

Correspondence Address: VOITH FABRICS, 3040 BLACK CREEK ROAD, P.O. BOX 1411, WILSON, NC, 27893, US

(21) Appl. No.: 11/228,761

(22) Filed: Sep. 16, 2005

(30) Foreign Application Priority Data
Sep. 17, 2004 (DE) 10 2004 045 087.0

(51) Int. Cl. B05D 1/04

(52) U.S. Cl. 427/458

(57) ABSTRACT

A process for producing papermaking machine clothing having a basic structure, in which powdery and electrically charged polymer material is deposited uniformly on a free surface of the basic structure by means of electric attraction and the polymer material is then activated thermally and/or chemically, so that the polymer material bonds firmly to the basic structure.

### CROSS-REFERENCE TO RELATED APPLICATIONS

The present application claims priority under 35 U.S.C. §119 of German Patent Application No. 10 2004 044 570.2 filed on Sep. 15, 2004, the disclosure of which is expressly incorporated by reference herein in its entirety.

### BACKGROUND OF INVENTION

1. Field of the Invention

This invention relates to the production of clothing, such as forming fabrics, press felts, dryer fabrics and other industrial clothing, such as transfer belts, for a machine for producing and/or further processing fibrous webs, in particular paper, board, pulp or tissue.

2. Discussion of Background Information

Paper is normally produced in that, in the forming section, a paper fibrous suspension is introduced onto a forming fabric or between two forming fabrics and is subsequently gradually dewatered. The fibrous web formed in this way and having a dryness of about 1% is then led through the press section by means of press felts for further dewatering and, after that, is led through the drying section of the paper machine by means of dryer fabrics. In the case of tissue paper machines, the paper web is, for example, transferred from the press felt to a Yankee drying cylinder and then creped.

In order to increase the lifetime and the smoothness of the side of the clothing which comes into contact with the fibrous web to be produced, it has been proposed to coat this side.

For example, EP 0 367 739 describes applying a thin layer of polymer foam to the surface of a press felt.

From inhouse internal findings obtained by means of trials, it is known to deposit polymer particles on the nonwoven layer of a press felt. However, the trials showed only unsatisfactory penetration of the polymer particles into the nonwoven layer and therefore an only inadequate bond between the two layers.

In the application bearing the application number PCT/EP2004/050359, a description is given of introducing and applying polymer particles into and onto the nonwoven layer of a press felt by means of a suspension. The disadvantage here consists in an only unsatisfactory ability to control the penetration of the suspension into the nonwoven layer, for example caused by viscosity changes of the suspension or the like.

### SUMMARY OF THE INVENTION

The object of the present invention is to propose an alternative process for producing clothing for use in machines for producing and/or further processing, with which polymer particles can be deposited particularly uniformly and in a controlled manner.

According to the invention, a process for producing papermachine clothing having a basic structure in which polymer material is deposited on the basic structure is proposed, which is defined in that powdery and electrically charged polymer material is deposited uniformly on a free surface of the basic structure by means of electric attraction and the polymer material is then activated thermally and/or chemically, so that the polymer material bonds firmly to the basic structure.

The charged powdery polymer material is attracted by the free surface of the basic structure, the attraction being greater in those regions of the surface on which no polymer material has yet been deposited than in those regions on which polymer material has already been deposited. This leads to the uniform deposition of the polymer material on the entire surface.

Furthermore, depending on the attraction between the electrically charged and powdery polymer material and the free surface of the basic structure, it is possible to apply the powdery polymer material in a regulated and controlled manner to the surface of the basic structure, since the amount deposited is substantially influenced by the strength of the attraction forces.

Furthermore, as a result of the deposition by means of electric attraction, the necessity to deposit the polymer particles by means of a carrier medium, such as in a suspension, is rendered superfluous. In this way, the costs for the production are also reduced considerably.

The deposition of the powdery polymer material can be influenced, for example, by the magnitude of the electrical charge, that is to say that the polymer material is attracted and is therefore also deposited to different extents by the basic structure, depending on its charge. In order to achieve the most highly controlled deposition of the powdery polymer material, it is expedient if the polymer material is unagglomerated, so that each polymer particle is of substantially the same size and the same charge is assigned to this. According to a preferred embodiment of the invention, provision is accordingly made for the polymer material to be deposited to be treated in such a way that this forms a cloud of unagglomerated polymer powder. A corresponding possibility for such a treatment can consist in swirling the powdery polymer material with air and at the same time charging it electrically with ionized air. In this case, the charged polymer particles contribute to the electric field between the polymer particles and the surface of the basic structure. The process is described in U.S. Pat. No. 5,094,883.

In order to be able to deposit the charged polymer particles on the basic structure of the clothing in a simple way, it is expedient if, for the purpose of deposition, the clothing runs through the cloud of charged polymer particles.

The charged and powdery polymer material is preferably deposited when the entire surface exposed to the polymer material is at the same electrical potential. In this way, an equipotential surface is created, on which it is particularly simple to deposit the polymer material in a controlled manner and uniformly.

By means of the type of deposition and/or the type of thermal and/or chemical activation, it is possible to exert an influence on whether the polymer material covers the surface of the basic structure completely or partly, whether the polymer material penetrates into the basic structure or not. Accordingly, preferred embodiments of the invention provide for the polymer material to be deposited and/or activated in such a way that it covers the basic structure in a closed manner. Furthermore, in such a way that the polymer material is deposited and/or activated in such a way that it covers the basic structure in a non-closed manner.

Furthermore, it is possible to deposit and/or activate the polymer material in such a way that this penetrates at least partly into the basic structure. This is possible, for example, when the electric attraction force is set in such a way that this reaches into the basic structure.

Furthermore, the invention provides for it to be possible to influence the particle size distribution of the powdery polymer material by selecting the deposition and/or activation parameters.

The process according to the invention is preferably used for depositing powdery polymer material onto a basic structure which is a nonwoven layer having fibers.

In this case, the polymer material is preferably deposited and/or activated in such a way that a layer is created which contains fibers and a polymer-fiber matrix. Such a layer is particularly suitable as the paper side of a press felt, which has a smooth surface with a high water absorption capacity with high wear resistance.

The polymer material is preferably deposited and/or activated in such a way that the permeability is virtually not reduced by the polymer-fiber matrix. This is primarily achieved by the powdery and electrically charged polymer material being deposited in such a way that this is deposited substantially only along the fibers.

According to a preferred refinement of the invention, use is made in the process according to the invention of polymer material which is thermoplastic and/or thermosetting.

In this case, the thermoplastic polymer material can be one which contains polyester and/or polyester urethane and/or polyurethane.

Of course, the polymer material can be applied in such a way that a plurality of layers of polymer material are applied after one another.

In order to be able to set the properties of the papermachine clothing optimally in accordance with the requirements on the respective application and use, provision is made that, in accordance with the process of the invention, the polymer material is deposited and/or activated in such a way that the polymer material of each layer and/or different layers has different particle sizes and/or different melting points and/or different degrees of hardness.

In the process according to the invention, use is preferably made of a polymer material having a particle size between 0.1 and 600 micrometers, preferably having a particle size between 1 and 300 micrometers, particularly preferably in the range between 20 and 150 micrometers.

The thermal activation is preferably effected by radiation.

The chemical activation is preferably effected by reactive agents.

In this case, provision can be made for the polymer material to melt as a result of the thermal and/or chemical activation and/or to react chemically and/or to pass through a phase conversion.

Furthermore, clothing which has been produced by the process according to the invention is to be protected.

In the following text, the process according to the invention will be explained in more detail by using schematic drawings, not to scale, in which:

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an apparatus in side view for carrying out an embodiment of the process according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

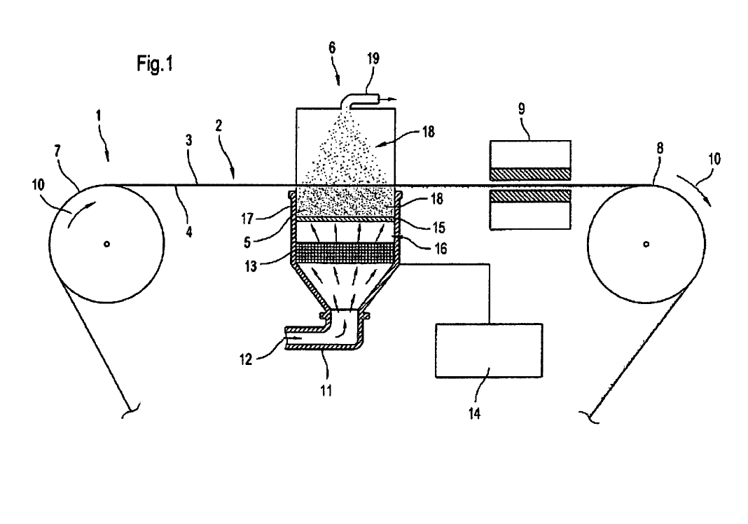

FIG. 1 shows an apparatus 1 for carrying out the process according to the invention for producing papermachine clothing 2.

The papermachine clothing 2 has a basic structure 3 with a free surface 4, on which powdery polymer material 5 is to be deposited.

In the present exemplary embodiment, the apparatus 1 has a deposition chamber 6, an activation chamber 9 and two rollers 7 and 8 for transporting the endlessly formed papermachine clothing 2 (illustrated in broken form in FIG. 1).

In accordance with the indicated direction of rotation 10 of the rollers 7 and 8, first of all the powdery polymer material 5 is deposited on the surface 4 of the basic structure 3 of the papermachine clothing 2 in the deposition chamber 6, before it is subsequently thermally activated in the activation chamber 9, formed as a heating chamber, and, in the present case, is fused to the basic structure 2.

The deposition chamber 6 has an air inlet opening 11 through which air 12 is led into the deposition chamber 6. The air 12 led in is led through an air-permeable electrode 13, which is kept at a high electrical potential by means of a high voltage device 14 (for example 0-90 kV). The air 12 led in is ionized by the electrode 13 as it is led through.

The ionized air 16 is then led through an air-permeable plate 15 with a high flow resistance into a container in which there is the powdery polymer material 5. The air-permeable plate 15 can optionally also be moved by a mechanism, for example shaken.

The powdery polymer material 5 is charged electrically by the ionized air 13. As a result of the mutual repulsion of the electrically charged polymer particles and as a result of the through flow, the powdery polymer material 5 is swirled in such a way that a cloud 18 of unagglomerated and electrically charged powdery polymer material is formed.

In order to deposit the electrically charged and powdery polymer material 5, the clothing 2 is transported through the cloud 18, as a result of which the polymer material 5 is deposited uniformly on the free surface 4 of the basic structure 3 by means of electrical attraction.

In this case, the entire surface 4 exposed to the polymer material 5 in the deposition chamber 6 is at the same electrical potential. Part of the cloud 18 is conveyed out of the deposition chamber 6 via an extraction line 19.

After the polymer material 5 has been deposited on the free surface 4, the clothing 2 is subsequently transported into the activation chamber 9, where the polymer material 5 is activated thermally with the aid of radiant heat, so that the polymer material 5 bonds firmly to the basic structure 3.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present extends to all functionally equivalent structures, methods and uses, such as are within the scope of the appended claims.

1. A process for producing papermaking machine clothing having a basic structure, comprising the steps of depositing powdery and electrically charged polymer material on a free surface of the basic structure by means of electric attraction and activating the polymer material at least one of termal activation and chemical activation, so that the polymer material bonds firmly to the basic structure.

2. The process as claimed in claim 1, wherein the polymer material to be deposited is treated in such a way that this forms a cloud of unagglomerated polymer powder.

3. The process of claim 2, wherein the clothing runs through the cloud of charged polymer powder.

4. The process of claim 1,
wherein the entire surface exposed to the polymer material is at the same electrical potential.

5. The process of claim 1,
wherein the polymer material is at least one of deposited and melted in such a way that the polymer material covers the basic structure in a closed manner.

6. The process of claim 1,
wherein the polymer material is at least one of deposited and melted in such a way that this covers the basic structure in a non-closed manner.

7. The process of claim 1,
wherein the polymer material is at least one of deposited and melted in such a way that this penetrates at least partly into the basic structure.

8. The process of claim 1,
wherein the basic structure is a nonwoven layer having fibers.

9. The process of claim 1,
wherein polymer material is at least one of deposited and melted in such a way that a layer is created which contains fibers and a polymer-fiber matrix.

10. The process of claim 1,
wherein the polymer material is at least one of thermoplastic and thermosetting.

11. The process of claim 1,
wherein the polymer material is a thermoplastic polymer, and the thermoplastic polymer material contains at least one of polyester, polyester urethane and polyurethane.

12. The process of claim 1,
wherein a plurality of layers of polymer material are applied after one another.

13. The process of claim 12,
wherein the polymer material of at least two layers has at least one of different particle sizes, different melting points and different degrees of hardness.

14. The process of claim 1,
wherein the polymer material has a particle size between 0.1 and 600 micrometers.

15. The process of claim 1,
wherein the polymer material is activated.

16. The process of claim 15
wherein the activation is thermal activation.

17. The process of claim 15
wherein the activation is chemical activation effected by reactive agents.

18. The process of claim 15,
wherein the polymer material melts as a result of at least one of thermal activation and chemical activation and reacts chemically and/or passes through a phase conversion.

19. Clothing produced by a process of claim 1.

20. The process of claim 1,
wherein the polymer material has a particle size between 1 and 300 micrometers.

21. The process of claim 1,
wherein the polymer material has a particle size between 20 and 150 micrometers.
